(19) United States
(12) Patent Application Publication
(10) Pub. No.: US 2025/0315123 A1
(43) Pub. Date: Oct. 9, 2025

(54) TOUCH DEVICE CONTROL METHOD AND TOUCH DEVICE WHICH CAN PROVIDE HAND WRITING FUNCTION

(71) Applicant: PixArt Imaging Inc., Hsin-Chu City (TW)

(72) Inventor: Chi-Chieh Liao, Hsin-Chu City (TW)

(73) Assignee: PixArt Imaging Inc., Hsin-Chu City (TW)

(21) Appl. No.: 19/240,007

(22) Filed: Jun. 17, 2025

Related U.S. Application Data
(63) Continuation-in-part of application No. 17/945,204, filed on Sep. 15, 2022, now Pat. No. 12,366,928.

(30) Foreign Application Priority Data
Apr. 19, 2022 (CN) 202210409118.4

(51) Int. Cl. G06F 3/041; G06F 3/0354; G06F 3/04817; G06F 3/04883

(52) U.S. Cl. CPC G06F 3/0416; G06F 3/03547; G06F 3/0414; G06F 3/04817; G06F 3/04883; G06F 2203/04108

(57) ABSTRACT

A touch device control method, comprising: the touch device continuously reporting touch positions of the object in a first mode, wherein the object keeps providing a sensing amount which is larger than an approaching threshold to the sensor in the first mode; and the touch device switches to operate in a second mode responding to that the sensing amount is larger than the switching threshold, wherein the touch device reports the touch positions and a pseudo mode switch signal in the second mode without triggering a specific button, wherein the pseudo mode switch signal is identical with a mode switch signal which is generated when the specific button is triggered; wherein the approaching threshold is smaller than the switching threshold. By this way, the handwriting function can be triggered without continuously pressing a specific button.

### CROSS REFERENCE TO RELATED APPLICATIONS

This application claims the benefit of U.S. Provisional Application No. 63/670,129, filed on Jul. 12, 2024. Further, this application is a continuation-in-part of U.S. application Ser. No. 17/945,204, filed on Sep. 15, 2022. The contents of these applications are incorporated herein by reference.

### BACKGROUND OF THE INVENTION

### 1. Field of the Invention

The present invention relates to a touch device control method and a touch device, and particularly relates to a touch device control method and a touch device which can report the touch positions and a pseudo mode switch signal that is identical with a mode switch signal which is generated when the specific button is triggered.

### 2. Description of the Prior Art

Conventional touch devices (such as touch pads) may have a handwriting function, but when performing the handwriting function, the touch device may not operate in its normal mode (such as controlling a displayed cursor by touching the touch device with a finger). Therefore, the touch device must switch between the handwriting mode and the normal mode. In the prior art, a user often needs to continuously press a specific button when the touch device operates in the normal mode to switch the touch device from the normal mode to the handwriting mode. For example, when using a touch device operating in the normal mode, the user must continuously press a left button of the touch device or a left button of the mouse to make the touch device operate in the handwriting mode, but such practice may interfere with the user's operational convenience.

### SUMMARY OF THE INVENTION

One objective of the present invention is to provide a touch device control method which can trigger the handwriting function in a more convenient way.

Another objective of the present invention is to provide a touch device which can trigger the handwriting function in a more convenient way.

One embodiment of the present invention discloses a touch device control method, applied to a touch device with a sensor, comprising: the touch device continuously reporting touch positions of the object in a first mode, wherein the object keeps providing a sensing amount which is larger than an approaching threshold to the sensor in the first mode; determining whether the sensing amount is larger than a switching threshold in the first mode; and the touch device switches to operate in a second mode responding to that the sensing amount is larger than the switching threshold, wherein the touch device reports the touch positions and a pseudo mode switch signal in the second mode without triggering a specific button, wherein the pseudo mode switch signal is identical with a mode switch signal which is generated when the specific button is triggered; wherein the approaching threshold is smaller than the switching threshold.

Another embodiment of the present invention discloses a touch device, comprising: a sensor; and a processing circuit, configured to perform a touch device control method comprising: the touch device continuously reporting touch positions of the object in a first mode, wherein the object keeps providing a sensing amount which is larger than an approaching threshold to the sensor in the first mode; determining whether the sensing amount is larger than a switching threshold in the first mode; the touch device switches to operate in a second mode responding to that the sensing amount is larger than the switching threshold, wherein the touch device reports touch positions and a pseudo mode switch signal in the second mode without triggering a specific button, wherein the pseudo mode switch signal is identical with a mode switch signal which is generated when the specific button is triggered; wherein the approaching threshold is smaller than the switching threshold.

Still another embodiment of the present invention discloses: a touch device, comprising: a processing circuit, configured to receive sensing signals from a sensor and perform a touch device control method comprising: the touch device continuously reporting touch positions of an object on a touch pad when the object keeps providing a sensing amount which is larger than an approaching threshold to the sensor; determining whether the sensing amount is larger than a switching threshold; when the sensing amount is larger than the switching threshold, the touch device reports a touch position and a left button pressed signal without pressing the left button; wherein the approaching threshold is smaller than the switching threshold.

In view of above-mentioned embodiments, the handwriting function can be triggered without continuously pressing a specific button. By this way, the convenience of handwriting function for users can be increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating that the touch device operates in a first mode, according to one embodiment of the present invention.

FIG. 2 is a schematic diagrams illustrating that the finger is touching the touch device and the finger is hovering the touch device, according to embodiments of the present invention.

FIG. 3 is a schematic diagram illustrating that the touch device operates in a second mode, according to one embodiment of the present invention.

FIG. 4 is a block diagram illustrating that the touch device comprises a plurality of regions, according to one embodiment of the present invention.

FIG. 5, FIG. 6 and FIG. 7 are schematic diagrams illustrating operations of the touch device, according to different embodiments of the present invention.

FIG. 8 is a flow chart illustrating a touch device control method according to one embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices. In following embodiments, the touch device is a touch pad. However, touch device may be any other type of device.

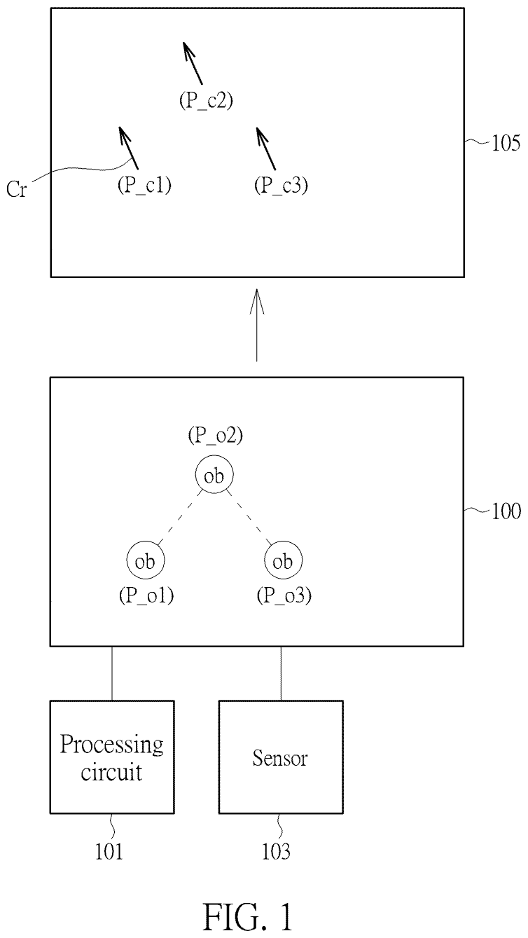

FIG. 1 is a schematic diagram illustrating that the touch device operates in a first mode, according to one embodiment of the present invention. As shown in FIG. 1, the touch device 100 comprises a processing circuit 101 and a sensor 103. The processing circuit 101 may be provided inside or below the touch device 100 rather than be provided outside the touch device 100. The processing circuit 101 is configured to receive sensing signals from the sensor 103, and is configured to perform a touch device control method. Details of the touch device control method will be described in following descriptions. The sensor 103 is configured to sense the sensing amount provided by an object Ob, which may be a finger or any other object which can be used to control the touch device 100 (e.g., a stylus). The sensor 103 may be various types of sensors, corresponding to the type of the touch device 100. For example, if the touch device 100 is an optical touch device, the sensor 103 is an optical sensor such as an image sensor. For another example, if the touch device 100 is a capacitive touch device, the sensor 103 is a capacitance sensor which can sense capacitance variation caused by the object Ob. In following embodiments, the touch device 100 is a capacitive touch device.

As above-mentioned, the touch device 100 operates in a first mode in FIG. 1. In such case, the touch device 100 continuously reports touch positions of the object Ob. These touch positions can be used to control targets shown on a screen, but not limited. For example, in FIG. 1, the object Ob moves from a touch position P_o1 to a touch position P_o2 and then to a touch position P_o3. The touch device 100 reports the touch positions P_o1, P_o2 and P_o3, and then a cursor Cr displayed on the screen 105 correspondingly moves from a position P_c1 to a touch position P_c2 and then to a touch position P_c3, corresponding to the touch positions P_o1, P_o2 and P_o3. In the embodiment of FIG. 1, the object Ob keeps providing a sensing amount which is larger than an approaching threshold to the sensor 103.

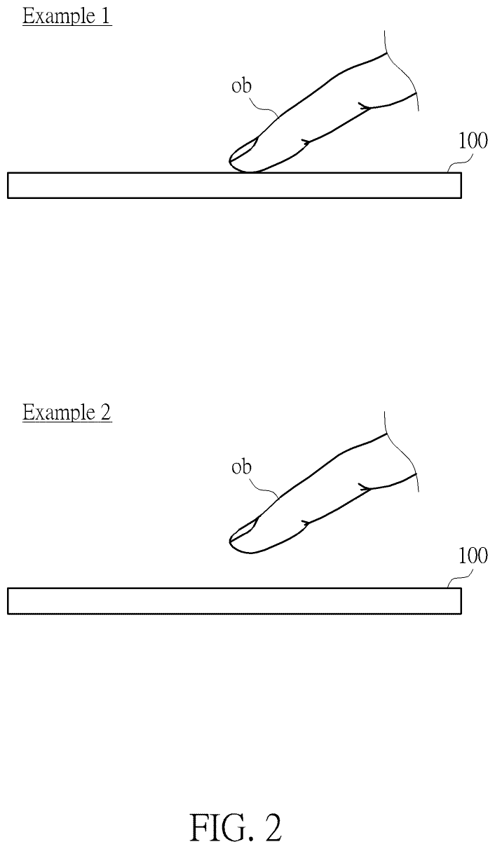

A touch device may be controlled by a direct touch or a non-direct touch. In example 1 of FIG. 2, the object Ob, which is a finger in FIG. 2, provides a direct touch to the touch device 100. Further, in example 2, the object Ob provides “hovering” (non-direct touch) to the touch device 100. The approaching threshold means “the threshold for an object to cause a directly touch” in one embodiment, and means “threshold for an object to cause hovering” in another embodiment. In other words, if the touch device 100 is a touch device which can sense direct touch, the description “the object Ob keeps providing a sensing amount which is larger than an approaching threshold to the sensor 103” means the object Ob provides a direct touch to the touch device 100 such that the sensing amount is larger than an approaching threshold which means “the threshold for an object to cause directly touch”. In such case, the sensor 103 is a force sensor, and the sensing amount is a force value. In one embodiment, the sensor 103 is a capacitance sensor, and the force value corresponds to capacitance variation sensed by the sensor 103. Further, the sensor 103 is an optical sensor, and the force value corresponds to the light amount sensed by the sensor 103.

Moreover, if the touch device 100 is a touch device which can sense hovering, the description “the object Ob keeps providing a sensing amount which is larger than an approaching threshold to the sensor 103” means the object Ob provides a hovering to the touch device 100 such that the sensing amount is larger than an approaching threshold which means “the threshold for an object to cause hovering”. In such case, the sensor 103 is a hovering sensor, and the sensing amount is a hovering value. In one embodiment, the sensor 103 is a capacitance sensor, and the hovering value corresponds to capacitance variation sensed by the sensor 103. Further, the sensor 103 is an optical sensor, and the hovering value corresponds to the light amount sensed by the sensor 103.

In following embodiments, the “direct touch” is used as an example for illustrating. However, the rules described below may also be applied to “hovering”.

Please refer to FIG. 1 again. In the first mode illustrated in FIG. 1, the processing circuit 101 continuously or periodically determines whether the sensing amount is larger than a switching threshold. The processing circuit 101 controls the touch device 100 to switch to operate in a second mode responding to that the sensing amount is larger than the switching threshold. The approaching threshold is smaller than the switching threshold. In other words, if the sensing amount is larger than the approaching threshold but smaller than the switching threshold, it means the object Ob is touching or hovering the touch device 100, but the touch device 100 still remain in the first mode when it is already in the first mode. On the contrary, if the sensing amount is larger than the switching threshold, it may mean that the object Ob presses the touch device 100 harder or getting closer to it thus creates a stronger hovering effect. In such case, the touch device 100 switches to the second mode when it is operating in the first mode. On the opposite, in the first mode, if the sensing amount becomes to be smaller than the approaching threshold, the touch device 100 does not report the touch positions and does not report a pseudo mode switch signal. Details of the pseudo mode switch signal will be described in following descriptions.

The embodiment of FIG. 1 can be regarded as that a “touch” of the object Ob is detected to determine whether the sensing amount is larger than the approaching threshold, and a “force” of the object Ob is detected to determine whether the sensing amount is larger than the switching threshold. The “touch” and the “force” may be detected sequentially. For example, the touch is firstly detected via a capacitance sensor in the touch device 100. After the object Ob touches the touch device 100, the “force” can be detected via the capacitance sensor.

In one embodiment, the “touch” and the “force” may be detected by different sensors in the touch device 100. For example, the “touch” is detected by an optical sensor and the “force” is detected by a capacitance sensor. Further, the “touch” and the “force” may be detected by different sensors in different devices. For example, the “touch” is detected by a touch sensor of a touch pad, and the “force” is detected by a capacitance sensor in a nib of a stylus.

In the second mode, the touch device 100 reports touch positions and the above-mentioned pseudo mode switch signal without triggering a specific button. The pseudo mode switch signal is identical with a mode switch signal which is generated when the specific button is triggered. In one embodiment, the touch device 100 is connected to a host device such as a computer, and the specific button is on a HID (Human interface device) connected to the host device. For example, the specific button is a left button of the touch device 100 or a mouse. In such example, the mode switch signal is a left button pressed signal. In such case, if an external control circuit, such as a CPU (Central Process Unit) of the host device, receives the touch positions and the pseudo mode switch signal reported from the touch device 100, a handwriting function is triggered.

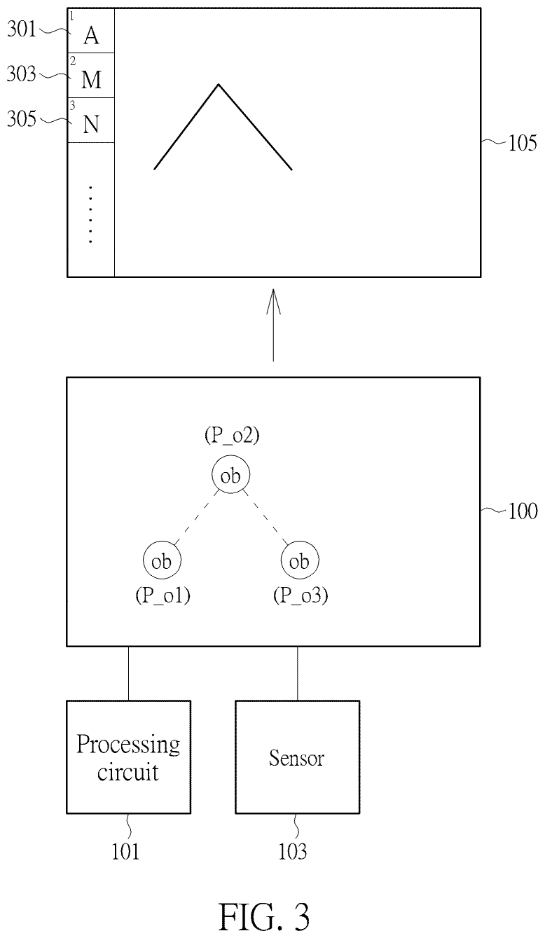

FIG. 3 is a schematic diagram illustrating that the touch device operates in a second mode, according to one embodiment of the present invention. In the embodiment of FIG. 1, the touch positions P_o1, P_o2 and P_o3 of the object Ob are used to correspondingly move the cursor Cr shown on the screen 105. In the embodiment of FIG. 3, the handwriting function is triggered, thus the touch positions P_o1, P_o2 and P_o3 form a part of a word or a letter (i.e., form at least one a stroke or a handwriting trace). As shown in the embodiment of FIG. 3, the touch positions P_o1, P_o2 and P_o3 may form a part of the letter A, M or N. In one embodiment, some candidate letters such as the candidate letters 301, 303 and 305 may be displayed thereby the user may quickly select a required letter. The letters shown in FIG. 3 may also be replaced by words, if the user writes a lot of strokes in a short time.

In one embodiment, the touch device 100 is connected to a host device (e.g., a computer) and comprises a handwriting region. In such case, a handwriting interface 400 may be displayed on a screen 105 connected to the host device. Coordinates of strokes in the handwriting interface 400 correspond to the touch positions in the handwriting region.

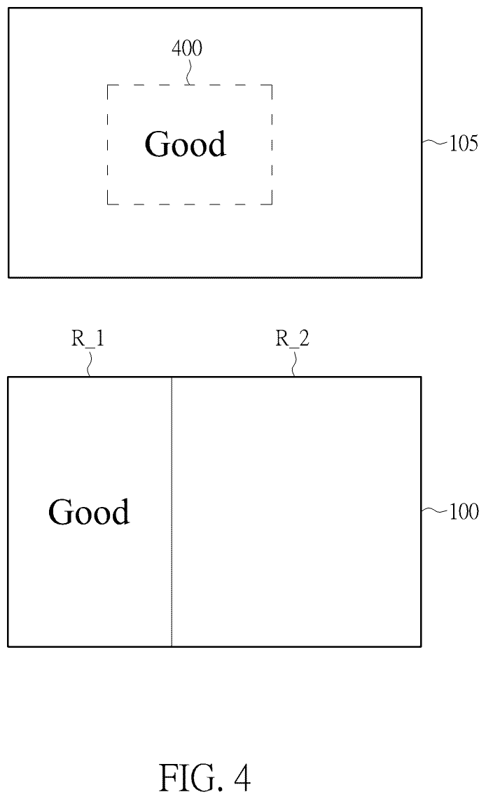

For example, in the embodiment of FIG. 4, the touch device 100 comprises a first region R 1 and a second region R 2. The first region R 1 is served as the handwriting region. In such case, the user provides strokes which form a word “Good” in the first region R 1. In such case, the strokes “Good” are also displayed in the handwriting interface 400, and the coordinates of the strokes “Good” in the handwriting interface 400 correspond to the touch positions (i.e., the strokes) in the handwriting region.

For more detail, in the embodiment of FIG. 4, the touch device 100 reports the touch positions and the pseudo mode switch signal in the second mode when the object Ob is in the first region R 1. In other words, the first region R 1 provides a handwriting function in the second mode. Additionally, the touch device 100 reports the touch positions and does not report the pseudo mode switch signal in the second mode when the object is in the second region R 2 and in the second mode. In other words, the second region R 2 provides normal touch control function even if the touch pad 100 operates in the second mode.

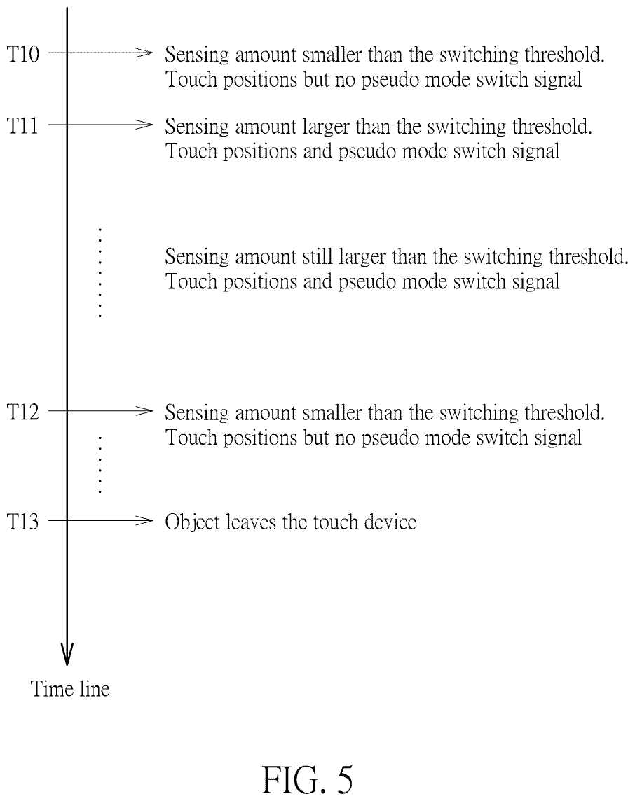

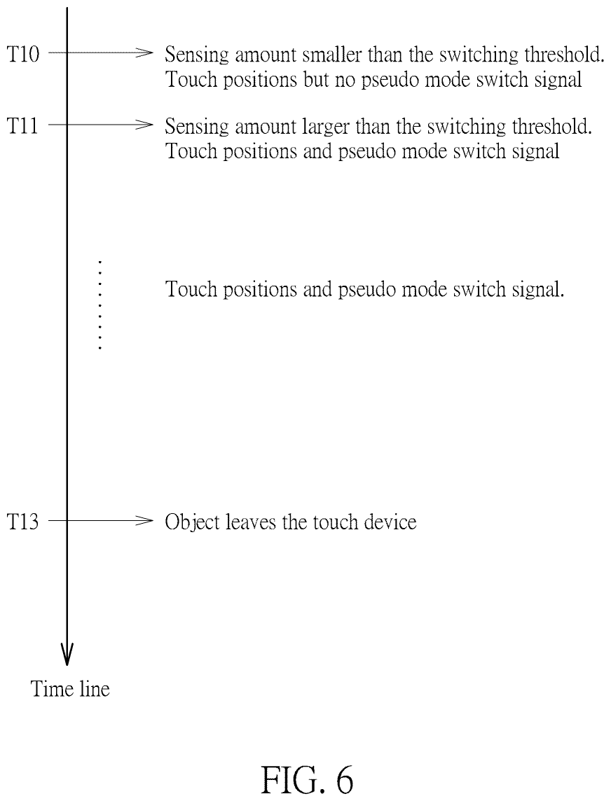

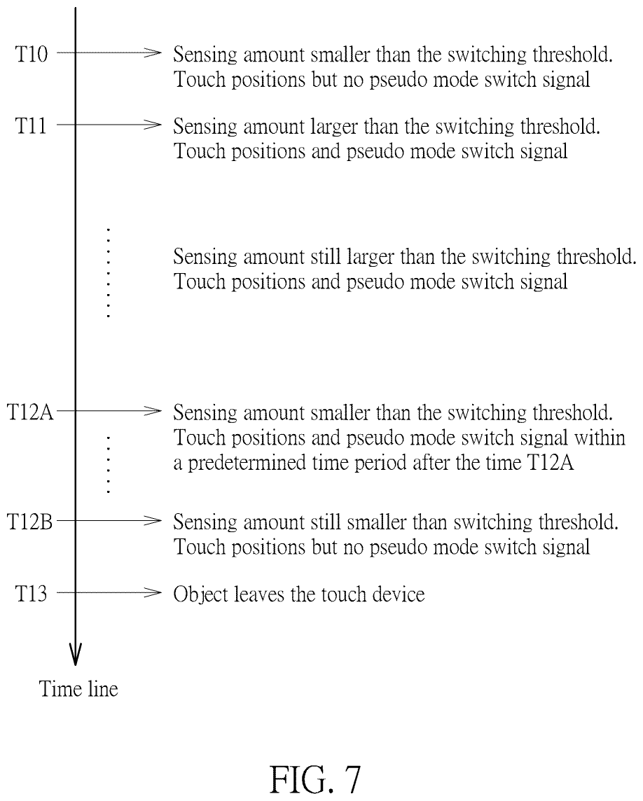

FIG. 5, FIG. 6 and FIG. 7 are schematic diagrams illustrating operations of the touch device, according to different embodiments of the present invention. In these diagrams, a timeline is drawn on the left, with the chronological order from top to bottom. For example, the time T11 is after the time T10, and the time T12 is after the time T11.

The operations shown in FIG. 5 are as follows:

At the time T10, the object Ob touches the touch device 100, but the sensing amount is smaller than the switching threshold. In such case, the touch device 100 reports touch positions but does not report the pseudo mode switch signal (i.e., operate in the first mode). As above-mentioned, an approaching threshold can be provided, and the touch device 100 can reports the touch positions corresponding to a relation between the sensing amount and the approaching threshold.

At the time T11, the object Ob touches the touch device 100, and the sensing amount is larger than the switching threshold. In such case, the touch device 100 reports touch positions and reports the pseudo mode switch signal (i.e., operate in the second mode).

During the time T11 and the time T12, the object Ob touches the touch device 100, and the sensing amount is still larger than the switching threshold. In such case, the touch device 100 continuously reports touch positions and reports the pseudo mode switch signal.

At the time T12, the object Ob touches the touch device 100, but the sensing amount becomes to be smaller than the switching threshold. In such case, the touch device 100 reports touch positions but does not report the pseudo mode switch signal (i.e., operate in the first mode).

At the time T13, the object Ob leaves the touch device 100.

In one embodiment, “leaves the touch device 100” means releasing a touch event. “Release a touch event” means transmitting object information, and sets a leave bit as “leave” by a symbol or a value. Following operations of “leaves the touch device 100” may also have the same meanings.

The operations shown in FIG. 6 are as follows:

At the time T10, the object Ob touches the touch device 100, but the sensing amount is smaller than the switching threshold. In such case, the touch device 100 reports touch positions but does not report the pseudo mode switch signal (i.e., operate in the first mode). As above-mentioned, an approaching threshold can be provided, and the touch device 100 can reports the touch positions corresponding to a relation between the sensing amount and the approaching threshold.

At the time T11, the object Ob touches the touch device 100, and the sensing amount is larger than the switching threshold. In such case, the touch device 100 reports touch positions and reports the pseudo mode switch signal (i.e., operate in the second mode).

During the time T11 and the time T13, the touch device 100 continuously reports touch positions and reports the pseudo mode switch signal. Please note, in the embodiment of FIG. 6, the touch device 100 still continuously reports touch positions and reports the pseudo mode switch signal even if the sensing amount becomes smaller than the switching threshold.

At the time T13, the object Ob leaves the touch device 100.

The operations shown in FIG. 7 are as follows:

At the time T10, the object Ob touches the touch device 100, but the sensing amount is smaller than the switching threshold. In such case, the touch device 100 reports touch positions but does not report the pseudo mode switch signal (i.e., operate in the first mode). As above-mentioned, an approaching threshold can be provided, and the touch device 100 can reports the touch positions corresponding to a relation between the sensing amount and the approaching threshold.

At the time T11, the object Ob touches the touch device 100, and the sensing amount is larger than the switching threshold. In such case, the touch device 100 reports touch positions and reports the pseudo mode switch signal (i.e., operate in the second mode).

During the time T11 and the time T12A, the object Ob touches the touch device 100, and the sensing amount is still larger than the switching threshold. In such case, the touch device 100 continuously reports touch positions and reports the pseudo mode switch signal.

At the time T12A, the object Ob touches the touch device 100, but the sensing amount becomes to be smaller than the switching threshold. In such case, the touch device 100 still reports touch positions and reports the pseudo mode switch signal within a predetermined time period after the time T12A.

In other words, the touch device 100 remains in the second mode for a predetermined time period after the sensing amount is smaller than the switching threshold.

At the time T12B, which is after the predetermined time period, the object Ob is still touching the touch device 100 but the sensing amount is still smaller than the switching threshold. In such case, the touch device 100 reports touch positions but does not report the pseudo mode switch signal. In other words, after the predetermined time period, the touch device 100 may switch to the first mode.

At the time T13, the object Ob leaves the touch device 100.

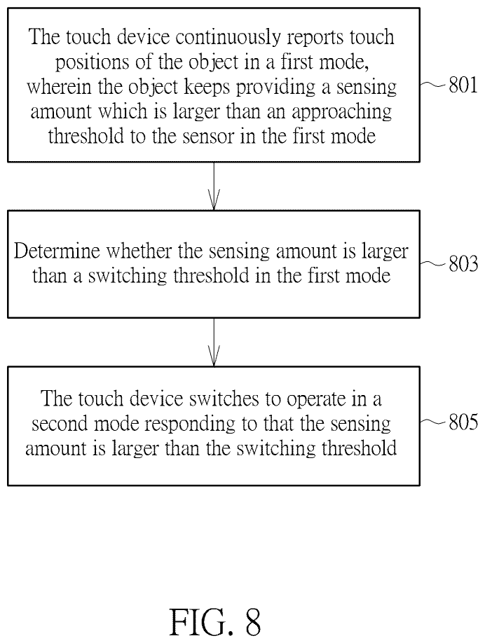

In view of above-mentioned embodiments, a touch device control method can be acquired, which is applied to a touch device with a sensor, such as the touch device 100 in FIG. 1. FIG. 8 is a flow chart illustrating a touch device control method according to one embodiment of the present invention. FIG. 8 comprises following steps:

### Step 801

The touch device continuously reports touch positions of the object in a first mode, wherein the object keeps providing a sensing amount which is larger than an approaching threshold to the sensor in the first mode.

### Step 803

Determine whether the sensing amount is larger than a switching threshold in the first mode.

### Step 805

The touch device switches to operate in a second mode responding to that the sensing amount is larger than the switching threshold.

The touch device reports the touch positions and a pseudo mode switch signal in the second mode without triggering a specific button, wherein the pseudo mode switch signal is identical with a mode switch signal which is generated when the specific button is triggered.

The approaching threshold is smaller than the switching threshold.

In view of above-mentioned embodiments, the handwriting function can be triggered without continuously pressing a specific button. By this way, the convenience of handwriting function for users can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch device control method, applied to a touch device with a sensor, comprising:
the touch device continuously reporting touch positions of the object in a first mode, wherein the object keeps providing a sensing amount which is larger than an approaching threshold to the sensor in the first mode;
determining whether the sensing amount is larger than a switching threshold in the first mode; and
the touch device switches to operate in a second mode responding to that the sensing amount is larger than the switching threshold, wherein the touch device reports the touch positions and a pseudo mode switch signal in the second mode without triggering a specific button, wherein the pseudo mode switch signal is identical with a mode switch signal which is generated when the specific button is triggered;
wherein the approaching threshold is smaller than the switching threshold.

2. The touch device control method of claim 1, further comprising:
the touch device remaining in the second mode for a predetermined time period after the sensing amount is smaller than the switching threshold.

3. The touch device control method of claim 1, wherein the sensor is a force sensor, and the sensing amount is a force value.

4. The touch device control method of claim 1, wherein the sensor is a hovering sensor, and the sensing amount is a force value.

5. The touch device control method of claim 1, further comprising:
the touch device not reporting the touch positions and not reporting the pseudo mode switch signal in the first mode responding to that the sensing amount is changed to be smaller than the approaching threshold.

6. The touch device control method of claim 1, wherein the touch device is a touch pad and the specific button is a button of the touch device.

7. The touch device control method of claim 6, wherein the touch device is connected to a host device and comprises a handwriting region, wherein the touch device control method further comprises:
displaying a handwriting interface on a screen connected to the host device, wherein coordinates of handwriting traces in the handwriting region correspond to the touch positions in the handwriting region.

8. The touch device control method of claim 7, wherein touch device comprises a first region served as the handwriting region and comprises a second region, wherein the touch device control method further comprises:
the touch device reporting the touch positions and the pseudo mode switch signal in the second mode when the object is in the first region;
the touch device reporting the touch positions and not reporting the pseudo mode switch signal in the second mode when the object is in the second region.

9. The touch device control method of claim 1, wherein the touch device is connected to a host device, and the specific button is on a HID (Human interface device) connected to the host device.

10. A touch device, comprising:
a sensor; and
a processing circuit, configured to perform a touch device control method comprising:
the touch device continuously reporting touch positions of the object in a first mode, wherein the object keeps providing a sensing amount which is larger than an approaching threshold to the sensor in the first mode;
determining whether the sensing amount is larger than a switching threshold in the first mode;
the touch device switches to operate in a second mode responding to that the sensing amount is larger than the switching threshold, wherein the touch device reports touch positions and a pseudo mode switch signal in the second mode without triggering a specific button, wherein the pseudo mode switch signal is identical with a mode switch signal which is generated when the specific button is triggered;
wherein the approaching threshold is smaller than the switching threshold.

11. The touch device of claim 10, wherein the processing circuit controls the touch device to remain in the second mode for a predetermined time period after the sensing amount is smaller than the switching threshold, and then switches to the first mode.

12. The touch device of claim 10, wherein the sensor is a force sensor, and the sensing amount is a force value.

13. The touch device of claim 10, wherein the sensor is a hovering sensor, and the sensing amount is a hovering value.

14. The touch device of claim 10, wherein the touch device control method further comprises:
the touch device not reporting the touch positions and not reporting the pseudo mode switch signal in the first mode responding to that the sensing amount is changed to be smaller than the approaching threshold.

15. The touch device of claim 10, wherein the touch device is a touch pad and the specific button is a button of the touch device.

16. The touch device of claim 15, wherein the touch device is connected to a host device and comprises a handwriting region, wherein a handwriting interface is displayed on a screen is connected to the host device, wherein coordinates of handwriting traces in the handwriting region correspond to the touch positions in the handwriting region.

17. The touch device of claim 16, wherein touch device comprises a first region served as the handwriting region and comprises a second region, wherein the touch device control method further comprises:
the touch device reporting the touch positions and the pseudo mode switch signal when the object is in the first region in the second mode;
the touch device reporting the touch positions and not reporting the pseudo mode switch signal when the object is in the second region and in the second mode.

18. The touch device of claim 10, wherein the touch device is connected to a host device, and the specific button is on a HID connected to the host device.

19. A touch device, comprising:
a processing circuit, configured to receive sensing signals from a sensor and perform a touch device control method comprising:
the touch device continuously reporting touch positions of an object on a touch pad when the object keeps providing a sensing amount which is larger than an approaching threshold to the sensor;
determining whether the sensing amount is larger than a switching threshold;
when the sensing amount is larger than the switching threshold, the touch device reports a touch position and a left button pressed signal without pressing the left button;
wherein the approaching threshold is smaller than the switching threshold.
